(19) United States
(12) Patent Application Publication
(10) Pub. No.: US 2015/0034250 A1
(43) Pub. Date: Feb. 5, 2015

(54) LAMINATING APPARATUS

(71) Applicant: NISSHINBO MECHATORNICS INC., TOKYO (JP)

(72) Inventors: Toshihiro Masuda, Aichi (JP); Tadashi Nakao, Aichi (JP)

(21) Appl. No.: 14/387,840

(22) PCT Filed: Mar. 28, 2013
(86) PCT No.: PCT/JP2013/060260

§ 371 Date: Sep. 25, 2014

(30) Foreign Application Priority Data
Mar. 28, 2012 (JP) 2012-073271

(51) Int. Cl. B32B 37/10; B32B 37/06

(52) U.S. Cl. CPC B32B 37/10; B32B 37/06; B32B 37/1018; B32B 2457/00
USPC 156/382; 156/583.1

(57) ABSTRACT

The present invention is to provide a laminating apparatus which significantly improves the laminating efficiency of a workpiece such as a photovoltaic module. In order to significantly improve the laminating efficiency of a workpiece such as a photovoltaic module, at least one sub-laminating apparatus is disposed subsequent to a main laminating apparatus, a hot plate of the main laminating apparatus is formed in such a way that a heat-supplying section thereof configured to supply heat to the workpiece on the hot plate is made of a material having a thermal conductivity of not less than 110 (Wm⁻¹K⁻¹) and not more than 398 (Wm⁻¹K⁻¹), and a hot plate of the sub-laminating apparatus is formed in such a way that a heat-supplying section thereof configured to supply heat to the workpiece on the hot plate is made of a material having a thermal conductivity of not more than 20 (Wm⁻¹K⁻¹).

### TECHNICAL FIELD

The present invention relates to a laminating apparatus which uses a plurality of laminating laminators to laminate a workpiece such as a photovoltaic module placed on a hot plate by clamping the workpiece which is heated by the hot plate between the hot plate and a pressing member.

### BACKGROUND ART

In recent years, due to the problem of greenhouse gases or the like, a photovoltaic device which does not pollute the environment is gaining attention. A photovoltaic module constituting the photovoltaic device is formed by superposing a plurality of components such as a cover glass, a filler, a photovoltaic cell and a back sheet. In manufacturing a photovoltaic device of this type, a laminating apparatus is used to superpose the components of the photovoltaic device, and laminate the components while they are being heated in vacuum so as to cause these components to adhere to each other (for example, see Patent Document 1). The laminating apparatus is configured to work in such a way that after an upper chamber and a lower chamber are hermetically closed and depressurized, air is introduced into a diaphragm to clamp the photovoltaic module between the diaphragm and an upper surface of a heating plate (hot plate) so as to heat the photovoltaic module with the heating plate. Relating to such laminating apparatus, there has been disclosed one laminating apparatus provided with a sheet configured to enter between the upper chamber and the lower chamber (see Patent Document 2). The one laminating apparatus is configured to work in such a way that: the photovoltaic module is placed on the sheet; the sheet is moved so as to transport the photovoltaic module between the diaphragm and the heating plate (hot plate); and the photovoltaic module is clamped between the diaphragm and the sheet. There has been proposed another laminating apparatus which includes a heating plate (hot plate) provided in the upper chamber and is configured to work in such a way that: the photovoltaic module is placed on the sheet for transportation; and the photovoltaic module is clamped between a lower surface of the heating plate (hot plate) and the sheet (see Patent Document 3).

In the process of manufacturing a photovoltaic module, the laminating process is a process that requires a long processing time. Therefore, in order to ensure the required production numbers of the photovoltaic modules, it is needed to shorten the laminating time.

However, it is difficult for each of the laminating apparatuses described in Patent Documents 1 to 3 to laminate a large number of photovoltaic modules efficiently. In order to solve this problem, Patent Document 4 discloses a laminating apparatus in which two laminating apparatus are disposed adjacent to each other in parallel.

In the laminating apparatus described in Patent Document 4, since the two laminating laminators are disposed adjacent to each other, it is possible to save the installation space of a feeding conveyor; although the laminating time is comparably shortened as that when two laminating laminators are used, it is not shortened sufficiently.
Patent Document 1: Japanese Patent Laying-Open No. 2003-282920
Patent Document 2: Japanese Patent Laying-Open No. H11-204811
Patent Document 3: Japanese Patent Laying-Open No. H11-254526
Patent Document 4: Japanese Patent Laying-Open No. 2005-209883

### SUMMARY OF INVENTION

### Technical Problem

The present invention has been made in view of the aforementioned problems, and it is therefore an object of the present invention to provide laminating apparatus which is simple in structure and is capable of laminating a workpiece such as a photovoltaic module more efficiently.

### Solution to Problem

To attain an object of the present invention, a laminating apparatus according to a first aspect of the present invention includes: a main laminating apparatus and at least one sub-laminating apparatus disposed subsequent to the main laminating apparatus. A hot plate of the main laminating apparatus is formed in such a way that a heat-supplying section thereof configured to supply heat to the workpiece on the hot plate is made of a material having a thermal conductivity of not less than 110 (Wm⁻¹K⁻¹) and not more than 398 (Wm⁻¹K⁻¹), and a hot plate of the sub-laminating apparatus is formed in such a way that a heat-supplying section thereof configured to supply heat to the workpiece on the hot plate is made of a material having a thermal conductivity of not more than 20 (Wm⁻¹K⁻¹).

According to the first aspect of the present invention, since the heating-supplying section of the hot plate in the main laminating apparatus is formed by using a material having a higher thermal conductivity, it is possible to raise the temperature of the hot plate to a higher temperature in a shorter time than the prior art, and it is possible to heat the workpiece to a predetermined temperature in a shorter time. Thus, by increasing the temperature of the hot plate in the main laminating apparatus higher than the temperature of the hot plate in the sub-laminating apparatus and by combining the main laminating apparatus and the sub-laminating apparatus, it is possible to shorten the laminating time in comparison with the case where two laminating apparatuses are simply disposed.

The laminating apparatus according to a second aspect of the present invention is dependent on the first aspect of the present invention, wherein: the main laminating apparatus includes a hot plate and an upper case which is provided with a pressing member; the workpiece is placed on the hot plate; the upper case and the hot plate are hermetically closed; a lower chamber which is partitioned by the pressing member is put into vacuum and air is introduced into an upper chamber so as to laminate the workpiece heated by the hot plate by clamping the workpiece between the hot plate and the pressing member.

The laminating apparatus according to the second aspect replaces the lower case that has been used in a conventional laminating apparatus with a hot plate that is identical to the hot plate according to the first aspect of the present invention. Thereby, in addition to the effect obtained by the first aspect of the present invention, it is possible to make the apparatus simpler in structure and cheaper in price.

The laminating apparatus according to a third aspect of the present invention is dependent on the first aspect of the present invention, wherein: the main laminating apparatus and the sub-laminating apparatus each includes a hot plate and an upper case which is provided with a pressing member; the workpiece is placed on the hot plate; the upper case and the hot plate are hermetically closed; a lower chamber which is partitioned by the pressing member is put into vacuum and air is introduced into an upper chamber so as to laminate the workpiece heated by the hot plate by clamping the workpiece between the hot plate and the pressing member.

According to the laminating apparatus of the third aspect, the same effects can be obtained similar to the laminating apparatus of the second aspect.

The laminating apparatus according to a fourth aspect of the present invention is dependent on the first aspect of the present invention, wherein: the main laminating apparatus includes an upper case which is provided with a pressing member and a lower case which is provided with the hot plate; the workpiece is placed on the hot plate; the upper case and the lower case are hermetically closed; a lower chamber which is partitioned by the pressing member is put into vacuum and air is introduced into an upper chamber so as to laminate the workpiece heated by the hot plate by clamping the workpiece between the hot plate and the pressing member.

According to the laminating apparatus of the fourth aspect, the same effects can be obtained similar to the laminating apparatus of the first aspect.

The laminating apparatus according to a fifth aspect of the present invention is dependent on the first aspect of the present invention, wherein: the main laminating apparatus and the sub-laminating apparatus each includes an upper case which is provided with a pressing member and a lower case which is provided with the hot plate; the workpiece is placed on the hot plate; the upper case and the lower case are hermetically closed; a lower chamber which is partitioned by the pressing member is put into vacuum and air is introduced into an upper chamber so as to laminate the workpiece heated by the hot plate by clamping the workpiece between the hot plate and the pressing member.

According to the laminating apparatus of the fifth aspect, the same effects can be obtained similar to the laminating apparatus of the first aspect.

The laminating apparatus according to a sixth aspect of the present invention is dependent on any one of the first aspect to the fifth aspect of the present invention, wherein an electric heater is embedded in the hot plate of any of the main laminating apparatus and the sub-laminating apparatus.

According to the laminating apparatus of the sixth aspect of the present invention, since an electric heater is disposed on the hot plate, it is possible to raise the temperature of the hot plate in a shorter time than a conventional oil heater. Thus, it is possible to obtain the effect of the first aspect of the present invention significantly.

### BRIEF DESCRIPTION OF THE DRAWINGS

FIG. 1 is an explanatory view of a photovoltaic module serving as a workpiece in a laminating apparatus of the present invention.

FIG. 2 is an explanatory view of the laminating apparatus of the present invention.

FIG. 3 is an explanatory view of a laminating section of the laminating apparatus of the present invention.

FIG. 4 is an explanatory view of a laminating section of the laminating apparatus of the present invention.

FIG. 5 is explanatory view of a hot plate used in the laminating apparatus of the present invention.

FIG. 6 is an explanatory view of a sheath heater used in the hot plate of the laminating apparatus of the present invention.

FIG. 7 is an explanatory view of a laminating apparatus of another embodiment of the present invention.

### EXPLANATIONS OF LETTERS OR NUMERALS

10 workpiece (photovoltaic module)
13 filler
14 filler
100 laminating apparatus (main laminator)
101 laminating section
110 upper case
120 lower case
150 hot plate
130 conveying sheet
200 feeding conveyor
300 connection conveyor
400 laminating apparatus (sub-laminator)
500 discharge conveyor
600 laminating apparatus of another embodiment
650 hot plate
LM laminating apparatus

### DETAILED DESCRIPTION

Embodiments of the present invention will be described with reference to the drawings.

### <1> Workpiece (Photovoltaic Module)

Hereinafter, a workpiece 10 to be laminated in a laminating apparatus of the present invention will be described.

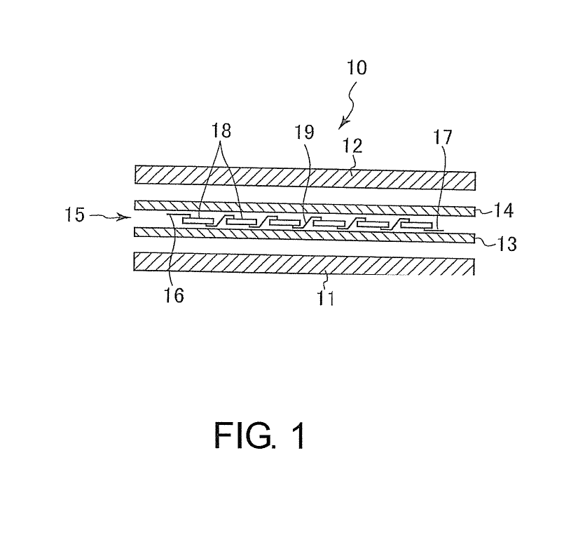

FIG. 1 is a sectional view illustrating the structure of a photovoltaic module which is made of crystalline cells and serves as the workpiece 10. As illustrated in the figure, the photovoltaic module 10 has such a structure that a plurality rows of strings 15 are filled by using fillers 13, 14 and thereafter clamped between a transparent cover glass 11 and a back sheet 12. The back sheet 12 is made of polyethylene resin material, for example. And, the fillers 13, 14 are made of EVA (ethylene vinyl acetate) resin or the like. Each string 15 is formed by connecting via a lead 19 a plurality of photovoltaic cells 18, each of which is a crystalline cell. The plurality rows of strings 15 are connected via a lead between electrodes 16 and 17.

The workpiece 10 may be the photovoltaic module described above, and may also be a generally-called thin-film photovoltaic module. To obtain a typical exemplary structure of the thin-film photovoltaic module, power generation elements composed of a transparent electrode, a semiconductor and a back electrode are preliminarily deposited on a transparent cover glass. In this kind of the thin-film photovoltaic module, the cover glass (substrate glass) is placed facing downward, then, the power generation elements on top of the cover glass are covered with a filler, and thereafter a back sheet is covered on the filler. At this state, the components of the thin-film photovoltaic module are heated in vacuum and lamination causes the components of the thin-film photovoltaic module to adhere to each other. In other words, the basic encapsulating structure of the thin-film photovoltaic modules is the same as that of the photovoltaic modules described above, and differs only in that the crystalline cells of the photovoltaic modules are replaced by vapor-deposited electricity-generating elements.

It should be noted that the laminating apparatus and the laminating method of the present invention can be applied to a thin-film photovoltaic module which is constructed in such a way that: a filler is covered on the substrate glass already vapor-deposited with the power generation elements; and a cover glass is covered on the filler thereafter.

### <2> Description on Schematic Structure of Laminating Apparatus of the Present Invention

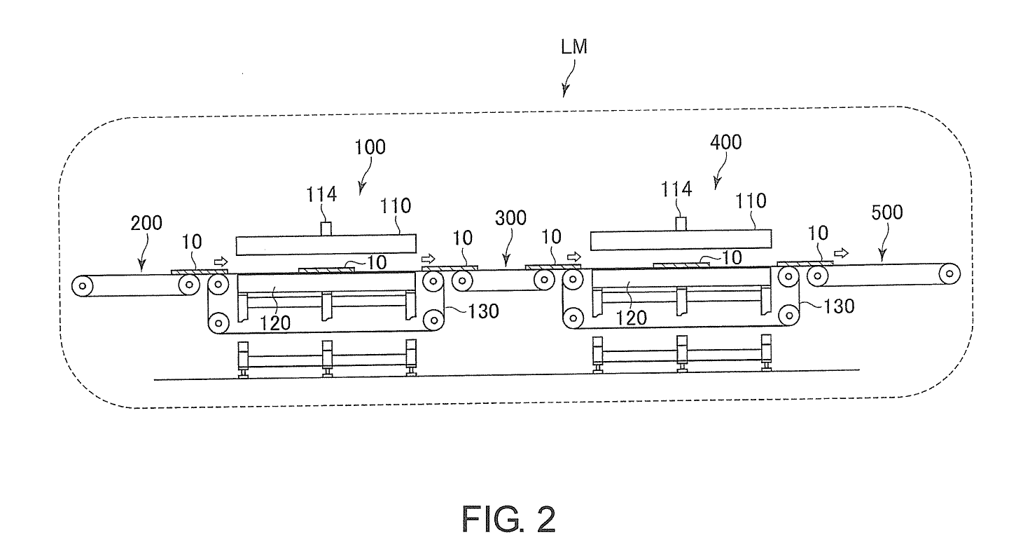

The laminating apparatus of the present invention is configured to include a main laminating apparatus (hereinafter, referred to as the main laminator) and at least one sub-laminating apparatus (hereinafter, referred to as the sub-laminator) disposed subsequent to the main laminating apparatus. The laminating apparatuses used respectively as the main laminator and the sub-laminator will be described with reference to FIG. 2.

The laminating apparatus LM of the present invention may be configured to include a plurality of sub-laminators 400 disposed subsequent to the main laminator 100 and separated away from the main laminator. As illustrated in FIG. 2, in the description of the present embodiment, only one sub-laminator is disposed subsequent to the main laminator; and the main laminator and the sub-laminator are connected via a conveyor or the like.

The main laminator and the sub-laminator may have different structures (different configurations). However, in the case that both have the same configuration, the description of the present embodiment is given. Since both are identical except the hot plate, the description is given of the structure of the main laminator. The main laminator 100 includes an upper case 110, a lower case 120, and a conveying sheet 130 configured to convey the workpiece 10. The conveying sheet 130 conveys the workpiece 10 between the upper case 110 and the lower case 120. The main laminator 100 is provided with a feeding conveyor 200 for conveying the workpiece 10 to be laminated to the main laminator 100. The main laminator 100 is further provided with a connection conveyor 300 configured to carry the laminated workpiece 10 out of the main laminator 100 and convey it to the sub-laminator 400. The feeding conveyor 200 and the connection conveyor 300 are connected to the main laminator. The workpiece 10 is transferred from the feeding conveyor 200 to the conveying sheet 130, and thereafter transferred from the conveying sheet 130 to the connection conveyor 300.

The workpiece 10 to be laminated in the sub-laminator 400 is fed from the connection conveyor 300 to the sub-laminator and laminated. After lamination, the workpiece 10 is transferred to a discharge conveyor 500. The connection conveyor 300 and the discharge conveyor 500 are connected to the sub-laminator.

The main laminator 100 is provided with an elevating device (not shown) composed of a cylinder, a piston rod and the like. The elevating device can lift up and lower down the upper case 110 relative to the lower case 120 while maintaining the upper case 110 horizontally. By lowering the upper case 110 via the elevating device, it is possible to hermetically seal an internal space between the upper case 110 and the lower case 120.

### <3> Laminating Section

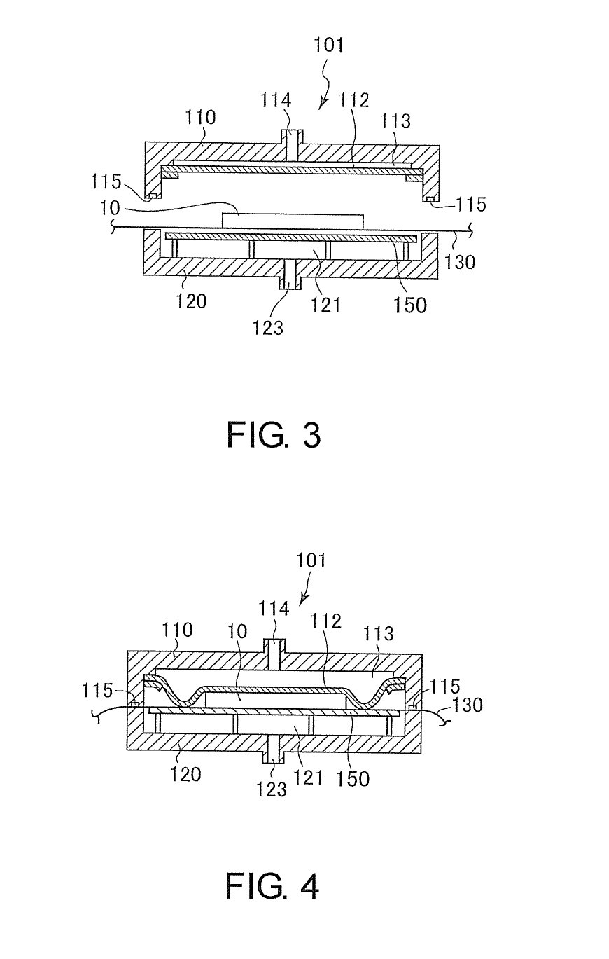

Hereinafter, the structure of a laminating section 101 in the main laminator 100 according to the present embodiment is described in more detail. Since the structure of a laminating section in the sub-laminator is identical to the structure of the laminating section 101, similar to <2>, the description is given of the main laminator only. FIG. 3 is a side cross-sectional view of the laminating section 101 before the workpiece 10 is laminated in the main laminator 100. FIG. 4 is a side cross-sectional view of the laminating section 101 when the workpiece 10 is laminated.

A downward opened space is formed in the upper case 110. A diaphragm 112 serving as a pressing member is disposed in the space to partition the space horizontally. The diaphragm 112 is molded from heat resistant rubber such as silicone-based rubber or the like. As described later, the diaphragm 112 functions as a pressing member which presses the workpiece 10 to be laminated. The upper case 110 is partitioned by the diaphragm 112 to form a space (an upper chamber 113).

The upper surface of the upper case 110 is provided with a port 114 which connects with the upper chamber 113. Through the port 114 of the upper chamber 113, it is possible to evacuate the upper chamber 113 to a vacuum state by using a vacuum pump or to introduce air into the upper chamber 113.

An upward opened space (lower chamber 121) is formed in the lower case 120. A hot plate 150 (a panel-shaped heater) is disposed in the space. The hot plate 150 is horizontally supported by a support member provided upright on a bottom surface of the lower case 120. At this state, the surface of the hot plate 150 is supported at a height substantially identical to that of an opening of the lower chamber 121. The hot plate 150 used in the sub-laminator has a different configuration which will be described later.

The lower surface of the lower case 120 is provided with a port 123 which connects with the lower chamber 121. Through the port 123 of the lower chamber 121, it is possible to evacuate the lower chamber 121 to vacuum by using a vacuum pump or to introduce air into the lower chamber 121.

The conveying sheet 130 is provided between the upper case 110 and the lower case 120 and movable on the hot plate 150. The conveying sheet 130 receives the workpiece 10 to be laminated from the feeding conveyor 200 illustrated in FIG. 2, and conveys the workpiece to a center position of the laminating section 101, that is, precisely to a center part of the hot plate 150. Moreover, the conveying sheet 130 transfers the workpiece 10 laminated in the main laminator to the connection conveyor 300 illustrated in FIG. 2.

### <4> Structure of Hot Plate

In the present embodiment, the hot plate 150 in the main laminator and in the sub-laminator is configured as follows. In the description of the present embodiment, since the basic structure of the hot plate in the main laminator and the basic structure of the hot plate in the sub-laminator are identical except that they are made of different materials, both are designated by the same reference numeral.

The hot plate 150 of the main laminator is formed in such a way that a heat-supplying section thereof configured to supply heat to the workpiece 10 on the hot plate is made of a material having a thermal conductivity of not less than 110 (Wm⁻¹K⁻¹) and not more than 398 (Wm⁻¹K⁻¹). In other words, in the main laminator, in order to raise the temperature of the workpiece 10 to be laminated faster, the material used to form the heat-supplying section of the hot plate has a thermal conductivity not less than that of aluminum alloy. Thereby, it is possible to conduct heat from the hot plate quickly to the workpiece so as to make the temperature of the workpiece reach a predetermined temperature early. Moreover, it is possible to set the temperature of the hot plate in the main laminator not lower than the cross-linking temperature of the filler inside the workpiece, which makes it possible to increase the temperature of the workpiece further rapidly. In addition, it is acceptable that the entire hot plate 150 is made of the above-mentioned material.

Meanwhile, the hot plate 150 of the sub-laminator is formed in such a way that a heat-supplying section thereof configured to supply heat to the workpiece on the hot plate is made of a material having a thermal conductivity of not more than 20 (Wm⁻¹K⁻¹). In other words, the heat-supplying section of the hot plate is made of a material having a thermal conductivity not more than that of stainless steel or the like. In the sub-laminator, the temperature of the hot plate is set to the cross-linking temperature of the filler inside the workpiece so as to accelerate the cross-linking reaction of the filler for the purpose of lamination. Thus, it is necessary to use such a material that has a small thermal conductivity but a large heat capacity (specific heat×density) other than the material having a high thermal conductivity such as aluminum alloy so as to maintain the temperature stably without fluctuations. Thereby, a material such as stainless steel is preferred. Similar to the main laminator, it is acceptable that the entire hot plate 150 is made of the above-mentioned material.

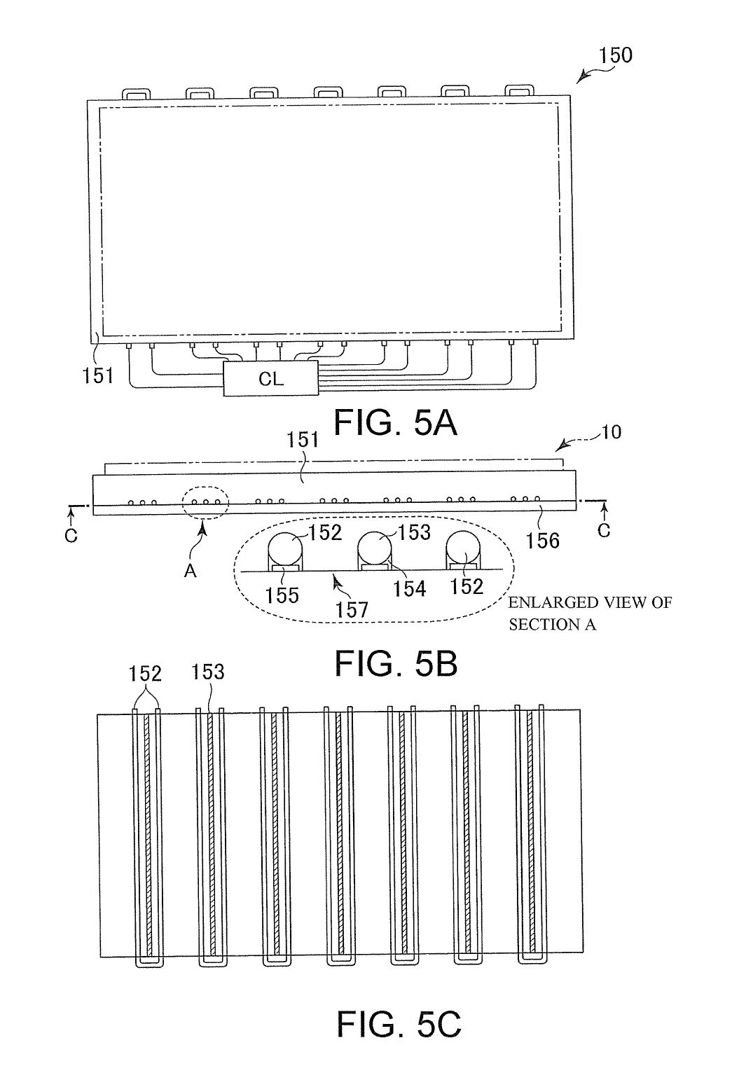

As an example, the hot plate used in the main laminator and in the sub-laminator may be an electric heater and may be constructed as illustrated in FIG. 5. In order to uniform the temperature distribution across the hot plate, a heat pipe may be used at the same time.

As illustrated in FIG. 5, the hot plate 150 is formed into a shape of a panel capable of supporting the workpiece 10 with the above-described material. In order to bury a heater 152 and a heat pipe 153, a housing groove 154 is machined in a hot plate body 151 in the depth direction. A plurality of U-shaped heaters 152 are arranged parallel to each other in the housing groove 154. The heat pipe 153 is provided at the center of U-shaped heaters 152 and parallel thereto. The heater 152 and the heat pipe 153 are buried in the housing groove 154 through the intermediary of a cushion material 155, covered with a back plate 156 of substantially the same dimensions as that of the hot plate body 151, and thereafter, the back plate 156 is fixed to the hot plate body 151 through bolts or the like. Thus, the outer periphery of the heater and the outer periphery of the heat pipe are in close contact with the bottom surface of the housing groove 154. The hot plate is provided with multiple sets of heater and heat pipes. The heater 152 may not have a U-shape, and a linear one may be also acceptable.

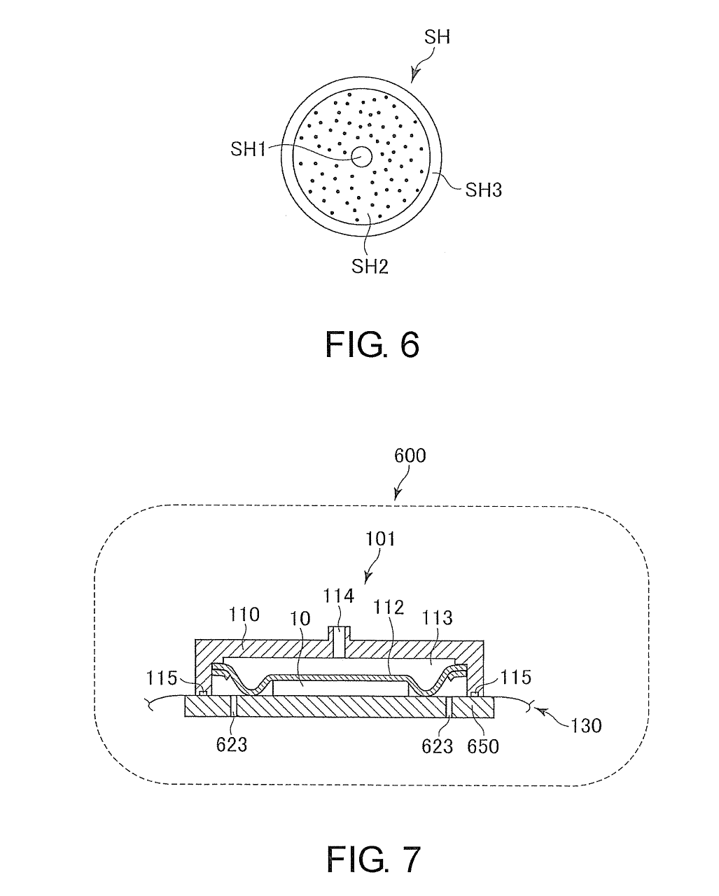

As the heater, a publicly known sheath heater SH may be usable. As illustrated in FIG. 6, the sheath heater SH is composed of: a nichrome wire SH1 which is formed into a coil at the center; an insulating material SH2 such as magnesium oxide or the like filled around the nichrome wire SH1; and a sheath SH3 (an outer cover serving as the outer circumference) covering the entire outer circumference of the insulating material SH2.

Any publicly known heat pipe can be used as the heat pipe 153. The heat pipe is hermetically closed with hydraulic fluid sealed inside at the state of saturated vapor pressure. Thus, when there is a temperature difference present in the length direction of the heat pipe, a vapor flow is generated from a high-temperature portion toward a low-temperature portion. The hydraulic fluid deprives the high-temperature portion of evaporation heat, and releases condensation heat at the low-temperature portion.

### <5> Lamination Method of the Present Invention

The details about the lamination process of the main laminator and the sub-laminator are described in <6>. The shortening of the laminating time is dependent on the shortening of the heating time of the workpiece during the lamination process. Therefore, if the temperature of the hot plate is set higher, the time raising the temperature of the workpiece will be shortened, and thereby, the heating time of the workpiece will be shortened. However, in the case where only one main laminator is used to perform the lamination process, it is difficult to set the temperature of the hot plate equal to or higher than the cross-linking temperature of the filler.

Thus, in the lamination method of the present invention, as illustrated in FIG. 2, a sub-laminator is disposed subsequent to the main laminator. With such a configuration, it is possible to set the temperature of the hot plate 150 in the main laminator equal to or higher than the cross-linking temperature of the fillers 13 and 14 filled inside the workpiece 10, and it is possible to quickly raise the temperature of the workpiece 10 placed on the hot plate close to the cross-linking temperature. The workpiece 10 which is heated around the cross-linking temperature is fed to the sub-laminator, and laminated once more. The temperature of the hot plate in the sub-laminator is set equal to the cross-linking temperature. The workpiece 10 is heated under pressure in the sub-laminator for a predetermined period of time to promote the cross-linking reaction of the fillers, and thereafter the lamination process is completed.

According to the lamination method of the present invention, compared with the case where the temperature of the hot plate in each of two main laminators is set to the cross-linking temperature and the two main laminators are driven to work simultaneously, the total laminating time is shortened and the production efficiency is significant improved.

### <6> Description of Laminating Steps by Main Laminator

Hereinafter, the lamination steps performed by the main laminator according to the present embodiment is described in detail. First, as illustrated in FIG. 3, the workpiece 10 is conveyed by the conveying sheet 130 to the center position of the laminating section 101.

Next, the elevating device lowers the upper case 110. As illustrated in FIG. 4, as the upper case 110 is lowered, the internal space between the upper case 110 and the lower case 120 is hermetically closed. In other words, the upper chamber 113 and the lower chamber 121 in the interior of the upper case 110 and the lower case 120 can be maintained at a hermetically closed state, respectively.

Then, the main laminator 100 evacuates the upper chamber 113 through the port 114 of the upper case 110 by using a vacuum pump. Similarly, the main laminator 100 evacuates the lower chamber 121 through the port 123 of the lower case 120 by using a vacuum pump (hereinafter, referred to as the vacuum step). The ultimate degree of vacuum in the vacuum step is specifically about 130 Pa, substantially the same level as that of a common laminating apparatus. Due to the evacuation of the lower chamber 121, gas bubbles or gas contained in the workpiece 10 is discharged outside of the workpiece 10.

The workpiece 10 is heated by the hot plate 150 which is heated under a temperature control by a temperature controller CL (see FIG. 5), and consequently, the fillers 13 and 14 contained inside the workpiece 10 are heated.

Thereafter, while maintaining the lower chamber 121 at the vacuum state, the main laminator 100 introduces air into the upper chamber 113 through the port 114 of the upper case 110. Thereby, a pressure difference is generated between the upper chamber 113 and the lower chamber 121, and as a result, the diaphragm 112 expands. Therefore, the diaphragm 112 is pushed downward (hereinafter, referred to as the pressurizing step), as illustrated in FIG. 4. The workpiece 10 is thereby clamped by the diaphragm 112 being pushed downward and the hot plate 150. While the workpiece 10 is being clamped, as described in <5>, the temperature of the hot plate in the main laminator 100 is set equal to or higher than the cross-linking temperature of the fillers inside the workpiece 10. Thus, the temperature of the workpiece 10 rises quickly. Moreover, the heat-melted fillers 13 and 14 cause the components to adhere to each other by clamping the workpiece.

At a certain time before the cross-linking reaction is completed, the main laminator 100 introduces air into the lower chamber 121 through the port 123 of the lower case 120. At this time, the elevating device lifts up the upper case 110. As illustrated in FIG. 3, after the upper case 110 is lifted up, it is possible to move the conveying sheet 130. The conveying sheet 130 transfers the laminated workpiece 10 to the connection conveyor 300.

### <7> Description of Laminating Steps by Sub-Laminator

Hereinafter, the lamination steps performed by the sub-laminator 400 according to the present embodiment is described in detail. First, the workpiece 10 that has been laminated in the main laminator and is placed on the connection conveyor 300 is conveyed by the conveying sheet 130 of the sub-laminator to the center position of the laminating section 101. The sub-laminator 400 puts into the state similar to that illustrated in FIG. 3.

Next, the elevating device lowers the upper case 110. As illustrated in FIG. 4, as the upper case 110 is lowered, the interior space between the upper case 110 and the lower case 120 is hermetically closed. In other words, the upper chamber 113 and the lower chamber 121 in the interior of the upper case 110 and the lower case 120 can be maintained at a hermetically closed state, respectively.

Then, the sub-laminator 400 evacuates the upper chamber 113 through the port 114 of the upper case 110 by using a vacuum pump. Similarly, the sub-laminator 400 evacuates the lower chamber 113 through the port 123 of the lower case 120 by using a vacuum pump (hereinafter, referred to as the vacuum step). Since the gas bubbles inside the workpiece has been discharged to the outside, the ultimate degree of vacuum in the vacuum step of the sub-laminator may be smaller than the ultimate degree of vacuum in the main laminator, and it may also be appropriately set according to the characteristics of the workpiece.

The workpiece 10 is heated by the hot plate 150 which is heated under the temperature control by a temperature controller CL (see FIG. 5). Similar to the main laminator, the fillers 13 and 14 (already in the molten state) contained inside the workpiece 10 are also heated.

Thereafter, while maintaining the lower chamber 121 at the vacuum state, the sub-laminator 400 introduces air into the upper chamber 113 through the port 114 of the upper case 110. Thereby, a pressure difference is generated between the upper chamber 113 and the lower chamber 121. As a result, the diaphragm 112 expands. Therefore, the diaphragm 112 is pushed downward (hereinafter, referred to as the pressurizing step), as illustrated in FIG. 4. The workpiece 10 is thereby clamped by the diaphragm 112 being pushed downward and the hot plate 150. While the workpiece 10 is being sandwiched, as described in <5>, the temperature of the hot plate in the sub-laminator 400 is set equal to the cross-linking temperature of the fillers 13 and 14 contained inside the workpiece 10, and thus, the temperature of the fillers and the like inside are kept at the cross-linking temperature for a certain period of time. Thereby, the cross-linking reaction of the fillers is promoted to achieve a desired cross-linking density, leading to the completion of the lamination process.

After the lamination of the workpiece 10 is completed, the sub-laminator 400 introduces air into the lower chamber 121 through the port 123 of the lower case 120. At this time, the elevating device lifts up the upper case 110. As illustrated in FIG. 3, after the upper case 110 is lifted up, it is possible to move the conveying sheet 130. The conveying sheet 130 transfers the laminated workpiece 10 to the discharge conveyor 500.

### <8> Another Exemplary Laminating Apparatus of the Present Invention

An embodiment of another exemplary laminating apparatus according to the present invention is described with reference to FIG. 7. The laminating apparatus of the present embodiment may be used in both the main laminator and the sub-laminator or may be used in either the main laminator or the sub-main laminator. In the description, a part having a structure and functions similar to that of the laminating apparatus illustrated in FIG. 3 is designated by the same reference number.

As illustrated in FIG. 7, a laminating apparatus 600 of the present embodiment is configured to include an upper case 110 and a lower case also serving as a hot plate 650. The workpiece 10 is conveyed to a predetermined position on the hot plate 650 by a conveying sheet 130 which travels above the hot plate 650. The lamination process is the same as that described from <5> to <7>. The vacuum step is performed via a port 114 of the upper case and through-holes 623 provided appropriately at several positions on the hot plate for discharging air downward. The pressurizing step is performed by a diaphragm 112 serving as a pressing member.

According to the laminating apparatus having the configuration of the present embodiment, it is possible to: shorten the laminating time as described in <5>; improve the production efficiency significantly; and make the apparatus significantly simple in structure and cheap in price.

It should be noted that though the present invention is described above according to the embodiments, the present invention is not limited thereto and obviously many modifications and variations are possible to the skilled persons in the art.

1. A laminating apparatus, comprising:
a main laminating apparatus and at least one sub-laminating apparatus disposed subsequent to the main laminating apparatus,
a hot plate of the main laminating apparatus being formed in such a way that a heat-supplying section thereof configured to supply heat to the workpiece on the hot plate is made of a material having a thermal conductivity of not less than 110 (Wm⁻¹K⁻¹) and not more than 398 (Wm⁻¹K⁻¹), and
a hot plate of the sub-laminating apparatus being formed in such a way that a heat-supplying section thereof configured to supply heat to the workpiece on the hot plate is made of a material having a thermal conductivity of not more than 20 (Wm⁻¹K⁻¹).

2. The laminating apparatus according to claim 1, wherein
the main laminating apparatus includes: an upper case which is provided with a pressing member, and a hot plate,
the workpiece is placed on the hot plate,
the upper case and the hot plate are hermetically closed,
a lower chamber which is partitioned by the pressing member is put into vacuum and air is introduced into an upper chamber, so as to laminate the workpiece heated by the hot plate by clamping the workpiece between the hot plate and the pressing member.

3. The laminating apparatus according to claim 1, wherein
the main laminating apparatus and the sub-laminating apparatus each includes: an upper case which is provided with a pressing member, and a hot plate,
the workpiece is placed on the hot plate,
the upper case and the hot plate are hermetically closed,
a lower chamber which is partitioned by the pressing member is put into vacuum and air is introduced into an upper chamber, so as to laminate the workpiece heated by the hot plate by clamping the workpiece between the hot plate and the pressing member.

4. The laminating apparatus according to claim 1, wherein
the main laminating apparatus includes: an upper case which is provided with a pressing member, and a lower case which is provided with the hot plate,
the workpiece is placed on the hot plate,
the upper case and the lower case are hermetically closed,
a lower chamber which is partitioned by the pressing member is put into vacuum and air is introduced into an upper chamber, so as to laminate the workpiece heated by the hot plate by clamping the workpiece between the hot plate and the pressing member.

5. The laminating apparatus according to claim 1, wherein
the main laminating apparatus and the sub-laminating apparatus each includes: an upper case which is provided with a pressing member, and a lower case which is provided with the hot plate,
the workpiece is placed on the hot plate,
the upper case and the lower case are hermetically closed,
a lower chamber which is partitioned by the pressing member is put into vacuum and air is introduced into an upper chamber, so as to laminate the workpiece heated by the hot plate by clamping the workpiece between the hot plate and the pressing member.

6. The laminating apparatus according to claim 1, wherein
an electric heater is embedded in the hot plate of any one of the main laminating apparatus and the sub-laminating apparatus.

7. The laminating apparatus according to claim 2, wherein
an electric heater is embedded in the hot plate of any one of the main laminating apparatus and the sub-laminating apparatus.

8. The laminating apparatus according to claim 3, wherein
an electric heater is embedded in the hot plate of any one of the main laminating apparatus and the sub-laminating apparatus.

9. The laminating apparatus according to claim 4, wherein
an electric heater is embedded in the hot plate of any one of the main laminating apparatus and the sub-laminating apparatus.

10. The laminating apparatus according to claim 5, wherein
an electric heater is embedded in the hot plate of any one of the main laminating apparatus and the sub-laminating apparatus.
